(19) United States
(12) Patent Application Publication
(10) Pub. No.: US 2020/0359795 A1
(43) Pub. Date: Nov. 19, 2020

(54) FURNITURE RETAINING APPARATUS

(71) Applicant: James J. Maltais, INDIAN LAND, SC (US)

(72) Inventor: James J. Maltais, INDIAN LAND, SC (US)

(21) Appl. No.: 16/867,833

(22) Filed: May 6, 2020

Related U.S. Application Data
(60) Provisional application No. 62/848,266, filed on May 15, 2019.

(51) Int. Cl. A47B 97/00; F16B 13/08

(52) U.S. Cl. CPC A47B 97/00; A47B 2097/008; F16B 13/08

(57) ABSTRACT

A furniture retaining apparatus includes a cord, engaging component, and retaining component. The cord is flexible and coupled to the engaging component. The retaining component is rotatably and slidingly coupled to the cord opposite the engaging component. The engaging component includes an engaging end that is configured to be driven through sheet rock panel. The engaging end has an overall shape that is elongated and pointed. The cord couples the engaging component to the retaining component. The retaining component inserts through an insertion orifice of a furniture item and frictionally couples adjacent thereto via a taut knot formed within the furniture item using the cord.

### CROSS-REFERENCE TO RELATED APPLICATIONS

This application claims priority to U.S. Provisional Application No. 62/848,266 filed May 15, 2019, which is hereby incorporated herein by reference.

### FIELD OF THE INVENTION

The present invention relates generally to devices for preventing the inadvertent tipping of furniture. More specifically, the present invention is a device wherethrough a furniture placed against a wall is prevented from being tipped away therefrom.

### BACKGROUND OF THE INVENTION

Every 17 minutes, a person is injured by a furniture, television, or appliance tip-over. A majority of the victims are children younger than 6 years old and involve dressers and other clothing storage units. For example, dressers and other clothing storage units account for at least 11 percent of furniture tip-over injuries.

Devices are available that are capable of preventing furniture from tipping over. However, these devices are penetrative and complicated. For example, some of these devices attach to a stud in the wall using a fastener, which may be difficult to locate or penetrate into. Also, some of these devices are permanent solutions to prevent furniture from tipping, which takes away the mobility benefit of most furniture.

Based on the foregoing, a need exists for furniture-tipping prevention devices that provide users with a non-penetrative means of attaching furniture items to wall structures that does not require the device to be attached to a stud in the wall structure and provides a simplified solution of preventing furniture tip-over events.

### BRIEF DESCRIPTION OF THE DRAWINGS

Some of the embodiments will be described in detail, with reference to the following figures, wherein like designations denote like members, wherein:

FIG. 1 depicts a furniture item positioned proximate to a wall according to some embodiments.

FIG. 2 illustrates the operational steps of a method to secure a furniture item to a wall according to other embodiments.

FIG. 3 illustrates the operational steps of a method to secure a furniture item to a wall according to certain embodiments.

FIG. 4 illustrates the operational steps of a method to secure a furniture item to a wall according to yet still other embodiments.

FIG. 5 illustrates the operational steps of a method to secure a furniture item to a wall according to some embodiments.

FIG. 6 depicts a furniture retaining apparatus according to other embodiments.

FIG. 7 illustrates an engagement component inserted through a wall according to certain embodiments.

FIG. 8 illustrates the operational steps of a method to secure a furniture item to a wall according to some embodiments.

FIG. 9 depicts a retaining component positioned proximate to a retaining orifice other embodiments.

FIG. 10 illustrates the operational steps of a method to secure a furniture item to a wall according to some embodiments.

FIG. 11 depicts a side view of the engagement component and the retaining component positioned adjacent to the wall and the furniture item, respectively, according to other embodiments.

FIG. 12 depicts a side view of the engagement component and the retaining component frictionally coupled to the wall and the furniture item, respectively, via a taut knot according to certain embodiments.

Unless otherwise specifically noted, articles depicted in the drawings are not necessarily drawn to scale.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “dorsal” refers to positions that are located near, on, or towards the upper or top side of a structure.

The instant disclosure includes many aspects and features. Moreover, while many aspects and features relate to, and are described in the context of a furniture retaining apparatus, embodiments of the instant disclosure are not limited to use only in this context.

Every 17 minutes, a person is injured by a furniture, television, or appliance tip-over. A majority of the victims are children younger than 6 years old and involve dressers and other clothing storage units. For example, dressers and other clothing storage units account for at least 11 percent of furniture tip-over injuries. Devices are available that are capable of preventing furniture from tipping over. However, these devices are penetrative and complicated. For example, some of these devices attach to a stud in the wall using a fastener, which may be difficult to locate or penetrate into. Also, some of these devices are permanent solutions to prevent furniture from tipping, which takes away the mobility benefit of most furniture.

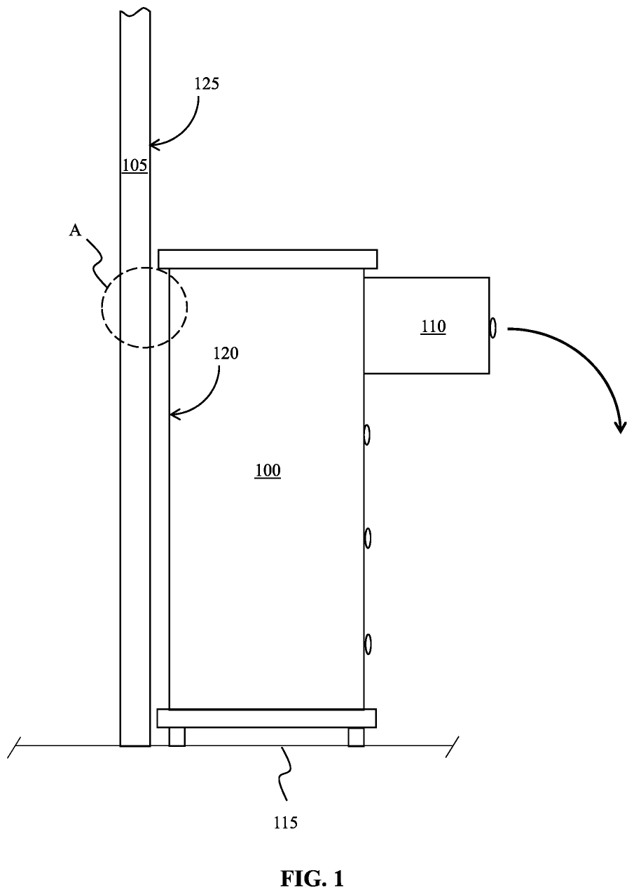

The instant disclosure seeks to provide a furniture retaining apparatus according to some embodiments. The instant disclosure also seeks to provide methods to secure furniture to wall structures without the need to locate and penetrate wall studs for attachment thereto. Further, the instant disclosure seeks to provide simplified methods to retain furniture in its upright position and thereby prevent tip-over injuries. With reference to FIG. 1, furniture, such as furniture item 100 is typically positioned near wall 105. The wall 105 preferably includes sheet rock paneling, for example sheet rock panel 125. Furniture item 100 can be any movable object that supports various human activities, such as storage (e.g., cabinets and chest of drawers), seating (e.g., chairs, stools, and sofas), eating (e.g., tables), and sleeping (e.g., beds).

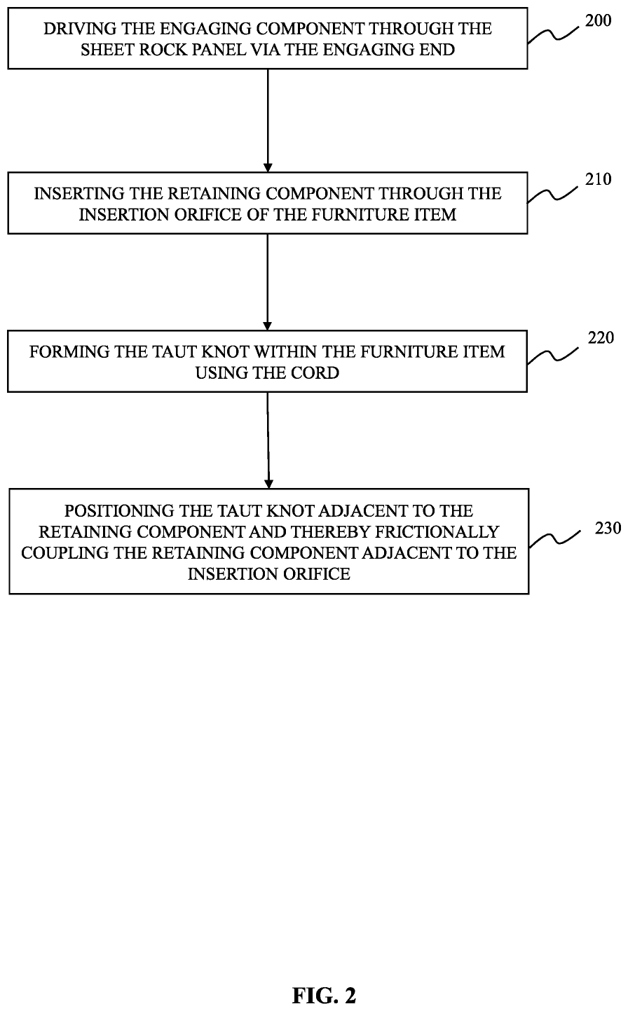

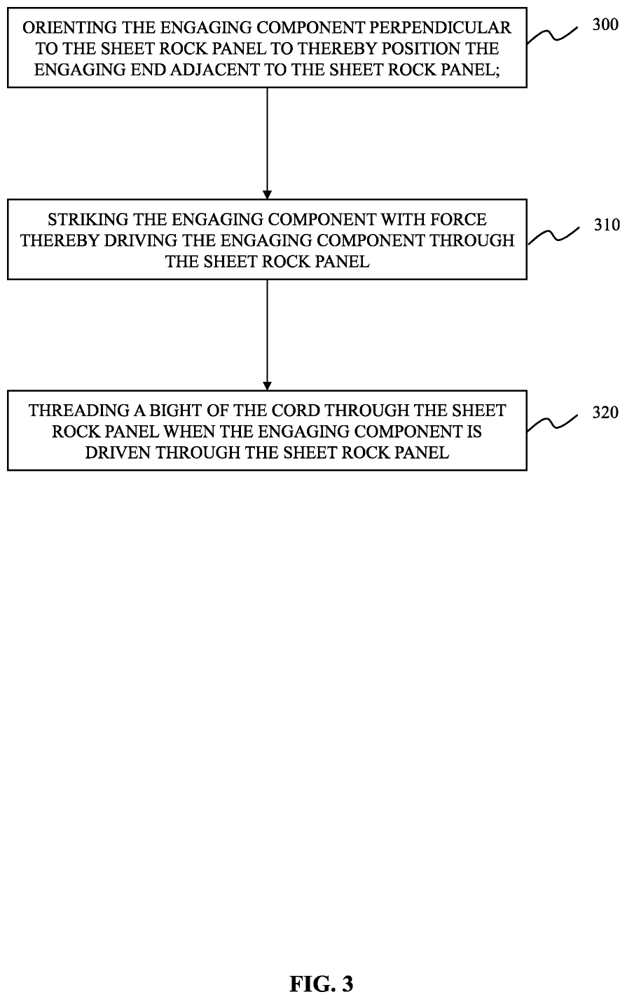

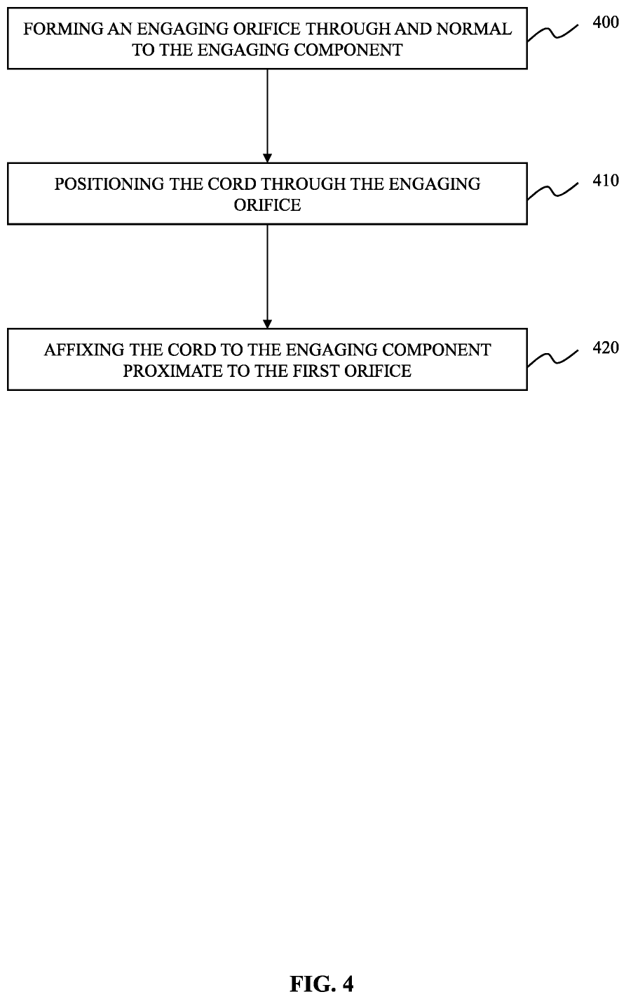

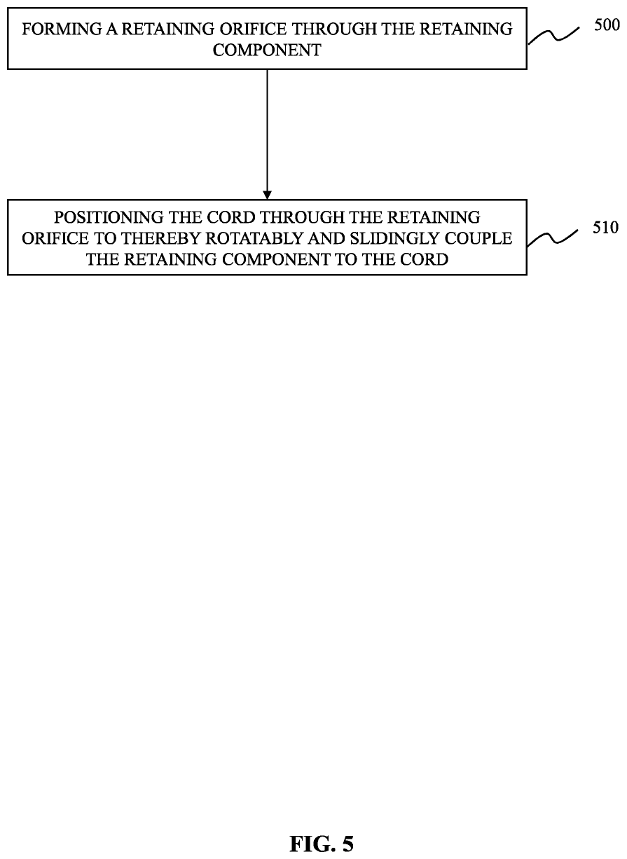

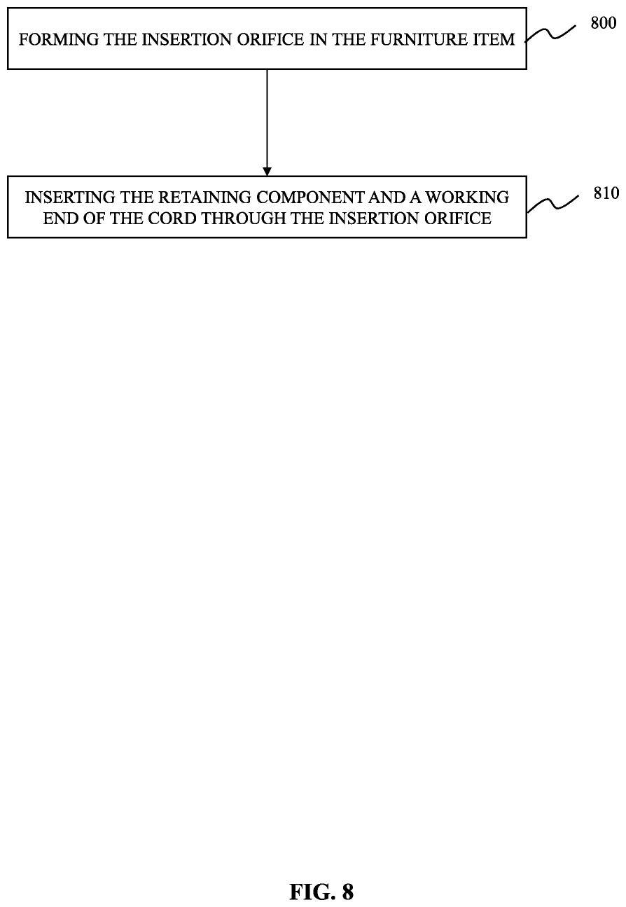

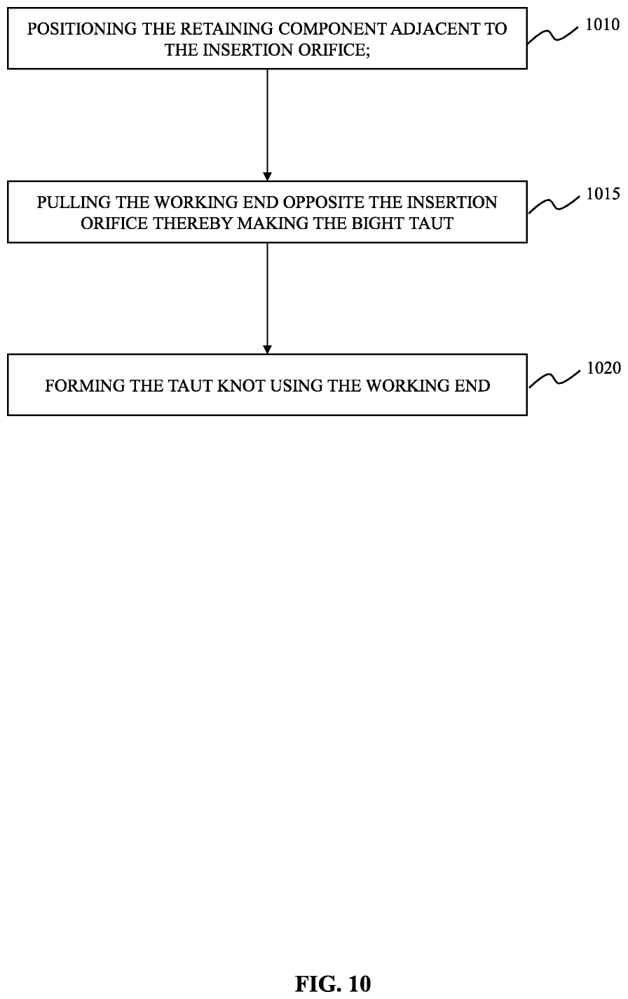

The furniture item 100 is preferably a cabinet or a chest of drawers having a frame 120 and drawer 110. For example, the risk that the furniture item 100 tips over increases as the drawer 110 is opened and the center of gravity for the furniture item 100 changes. To prevent the tip-over, the furniture item 100 should be secured the wall 105. View A is the preferred location to secure the furniture item 100 to the wall 105. With reference to FIGS. 2-12, the furniture item 100 item is preferably secured to the wall 105 using a furniture retaining apparatus 600. The furniture retaining apparatus 600 includes a cord 610, engaging component 605, retaining component 630. The cord 610 can be of any shape, size, material, features, type or kind, orientation, location, quantity, components, and arrangements of components to fulfill the objectives and intents of the instant disclosure. The cord 610 is preferably flexible. The cord 610 is configured to couple the engaging component to the retaining component according to preferred embodiments.

The cord 610 is preferably a nylon rope (e.g., paracord 550) having a breaking strength of 600 lbs. or more, and a minimum elongation of 30%. However, it is preferred that the cord 610 be of a material that is durable, strong, tear-resistant, less prone to fraying, easily manufacturable, and/or flexible. Such material can include, but is not limited to, the following: plastic, nylon, and other similar polymers. It is preferred that the cord 610 have a diameter that is smaller than the overall length of the cord. The cord 610 has a bight 640 and a working end 650. The bight 640 refers to any curved section, slack part, or loop between the ends of the cord 610 (e.g., between the engaging component 605 and the retaining component 630). The working end 650 refers to the active end of the cord 610 used to make the taut knot 1205.

The engaging component 605 can be of any shape, size, material, features, type or kind, orientation, location, quantity, components, and arrangements of components to fulfill the objectives and intents of the instant disclosure. In preferred embodiments, the engaging component 605 is coupled to the cord 610. The engaging component 605 preferably has an overall cylindrical shape and a length that is greater than its diameter. The retaining component 630 is rotatably and slidingly coupled to the cord 610 opposite the engaging component 605. The engaging component 605 preferably includes an engaging end 615. The engaging end 615 has an overall shape that is elongated and pointed. The engaging end 615 is configured to be driven through the sheet rock panels, e.g., the sheet rock panels 125. The engaging component 605 includes engaging orifice 620. The engaging orifice 620 traverses the engaging component 605 and is oriented normal to the engaging component 605. The cord 610 traverses the engaging orifice 602 and is affixed to the engaging component 605 proximate to the engaging orifice 602.

The retaining component 630 can be of any shape, size, material, features, type or kind, orientation, location, quantity, components, and arrangements of components to fulfill the objectives and intents of the instant disclosure. According to preferred embodiments, the retaining component 630 is configured to be inserted through insertion orifices located in furniture frames, e.g., the frame 120, and be frictionally coupled adjacent thereto via a retaining element, e.g., taut knot 1205. The retaining component 630 includes retaining orifice 635. The retaining orifice 620 traverses the retaining component 630. The retaining orifice 635 is preferably oriented normal to the retaining component 630. The retaining component 630 and/or the engaging component 605 can be formed using wood, metal (e.g., aluminum), and/or polymers (i.e. materials that are durable, strong, tough, easily manufacturable, and/or smooth). However, the retaining component 630 and/or the engaging component 605 are preferably made of wood.

With reference to FIGS. 2-5, the method to secure the furniture item 100 to the wall 105 using the furniture retaining apparatus 600 includes a plurality of steps. At step 200, the engaging component 605 is driven through the sheet rock panel 125 via the engaging end 650. At Step 210, the retaining component 630 is inserted through the insertion orifice 905 of the furniture item 100. At Step 220, the taut knot 1205 is formed within the furniture item 100 using the cord 610. At Step 230, the taut knot 1205 is positioned adjacent to the retaining component 630 and thereby frictionally coupling the retaining component 630 adjacent to the insertion orifice 635.

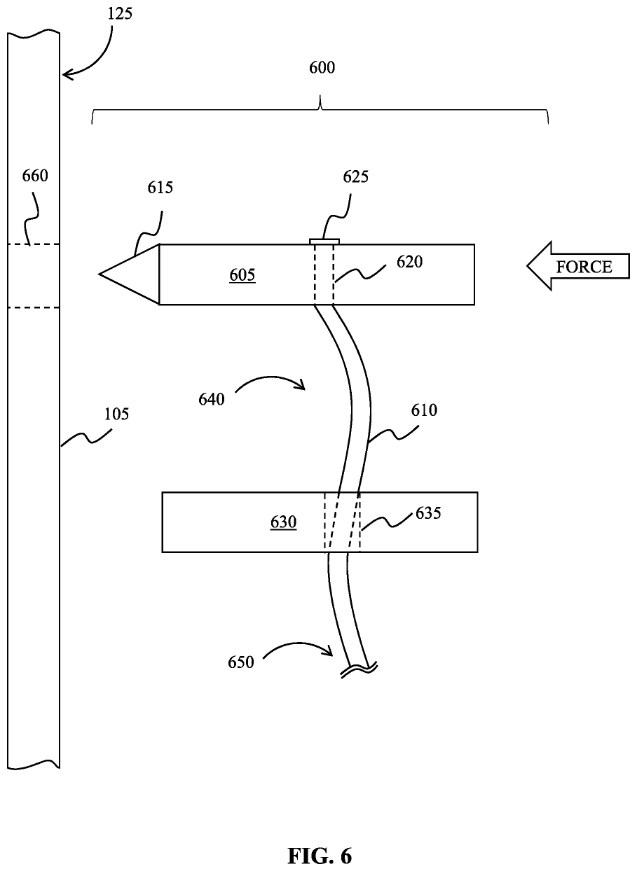

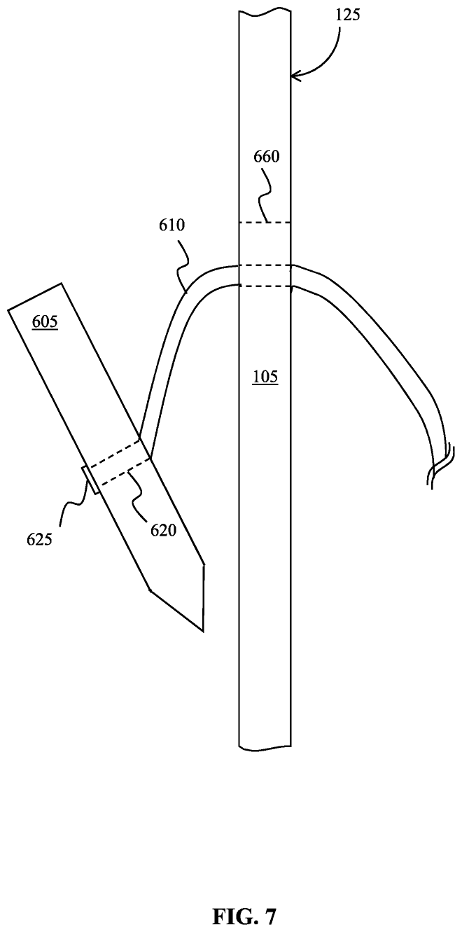

According to preferred embodiments, to drive the engaging component 605 through the sheet rock panel the engaging component 605 is oriented perpendicular to the sheet rock panel 125 to thereby position the engaging end 615 adjacent to the sheet rock panel 125 (Step 300). Referring to FIG. 6, the engaging component 605 is struck with force to drive the engaging component 605 through the sheet rock panel 125 (Step 310). As reflected in FIG. 7, bight 640 of the cord 610 is threaded through the sheet rock panel 125 when the engaging component 605 is driven through the sheet rock panel 125 (Step 320).

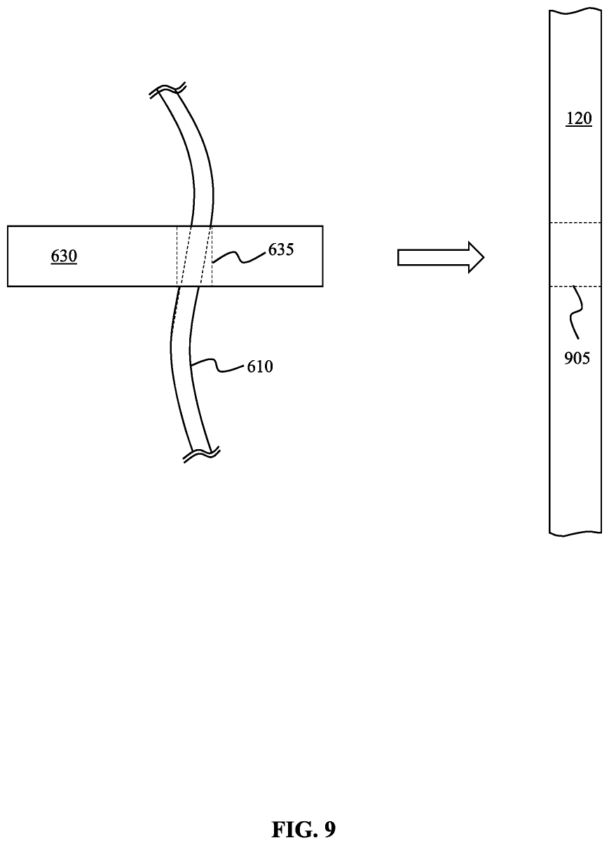

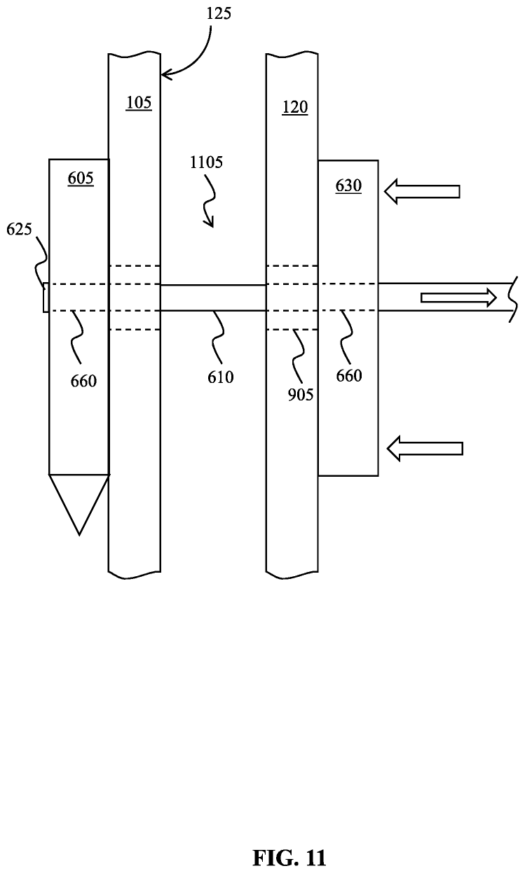

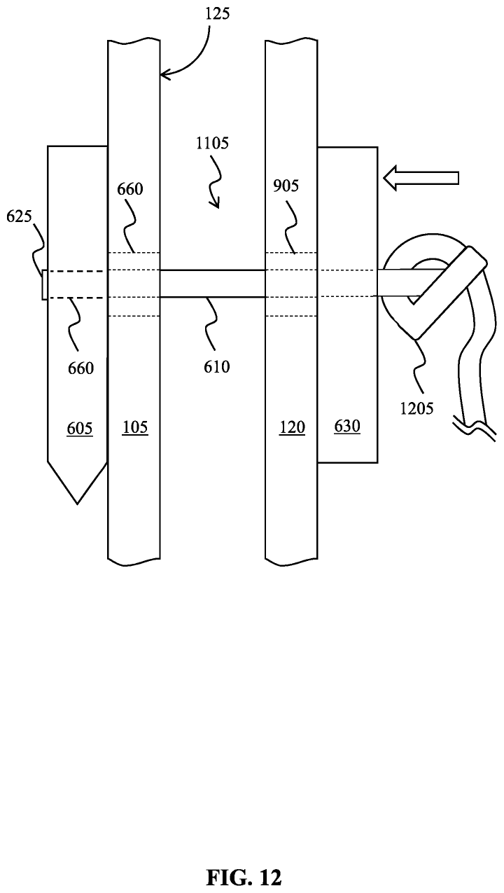

Referring to FIG. 9, to insert the retaining component 630 through the insertion orifice 905, the insertion orifice 905 is preferably formed in the furniture item 100 (Step 800). For example, the insertion orifice 905 can be formed using a drill or during the assembly process. The insertion orifice 905 has a diameter smaller than the length of the retaining component 630. At Step 810, the retaining component 630 and a working end 650 of the cord 610 is inserted through the insertion orifice 905. Referring now to FIGS. 11 and 12. To form the taut knot 1205 within the furniture item 100, the retaining component 630 is preferably positioned adjacent to the insertion orifice 905 (Step 1010). The working end 650 is pulled opposite the insertion orifice 905 thereby making the bight 640 taut (Step 1015). The taut knot 1205 is formed using the working end 650 (Step 1020).

Although the invention has been explained in relation to its preferred embodiment, it is to be understood that many other possible modifications and variations can be made without departing from the spirit and scope of the disclosure.

1. A furniture retaining apparatus, comprising:
a cord;
an engaging component;
a retaining component;
wherein
the cord is flexible;
the engaging component is coupled to the cord;
the retaining component is rotatably and slidingly coupled to the cord opposite the engaging component;
the engaging component comprises an engaging end;
the engaging end is configured to be driven through sheet rock panel;
the cord couples the engaging component to the retaining component; and
the retaining component is configured to be inserted through an insertion orifice of a furniture item and be frictionally coupled adjacent thereto via a taut knot formed within the furniture item using the cord.

2. The furniture retaining apparatus of claim 1, wherein the cord comprises nylon.

3. The furniture retaining apparatus of claim 2, wherein the cord comprising a breaking strength of 600 pounds or more.

4. The furniture retaining apparatus of claim 3, wherein the cord comprises a minimum elongation of 30%.

5. The furniture retaining apparatus of claim 4, wherein
the engaging component comprises an engaging orifice that traverses the engaging component;
the engaging orifice is oriented normal to the engaging component;
the cord traverses the engaging orifice; and
the cord is affixed to the engaging component proximate to the engaging orifice.

6. The furniture retaining apparatus of claim 5, wherein the engaging end comprises an overall shape that is elongated and pointed.

7. The furniture retaining apparatus of claim 6, wherein
the retaining component
comprises a retaining orifice;
traverses the retaining component; and
is oriented normal to the retaining component.

8. The furniture retaining apparatus of claim 7, wherein at least one of the engaging component and the retaining component comprise wood.

9. The furniture retaining apparatus of claim 7, wherein at least one of the engaging component and the retaining component comprise a polymer.

10. A method to enable the retaining of furniture using the furniture retaining apparatus of claim 1, comprising:
driving the engaging component through the sheet rock panel via the engaging end;
inserting the retaining component through the insertion orifice of the furniture item;
forming the taut knot within the furniture item using the cord; and
positioning the taut knot adjacent to the retaining component and thereby frictionally coupling the retaining component adjacent to the insertion orifice.

11. The method of claim 10, wherein driving the engaging component through the sheet rock panel comprises:
orienting the engaging component perpendicular to the sheet rock panel to thereby position the engaging end adjacent to the sheet rock panel;
striking the engaging component with force thereby driving the engaging component through the sheet rock panel; and
threading a bight of the cord through the sheet rock panel when the engaging component is driven through the sheet rock panel.

12. The method of claim 11, wherein inserting the retaining component through the insertion orifice of the furniture item comprises:
forming the insertion orifice in the furniture item; and
inserting the retaining component and a working end of the cord through the insertion orifice.

13. The method of claim 12, wherein forming the taut knot within the furniture item using the cord comprises:
positioning the retaining component adjacent to the insertion orifice;
pulling the working end opposite the insertion orifice thereby making the bight taut; and
forming the taut knot using the working end.

14. The method of claim 13, further comprising:
forming an engaging orifice through the engaging component, the engaging orifice oriented normal to the engaging component;
positioning the cord through the engaging orifice; and
affixing the cord to the engaging component proximate to the engaging orifice.

15. The method of claim 14, further comprising:
forming a retaining orifice through the retaining component; and
positioning the cord through the retaining orifice to thereby rotatably and slidingly couple the retaining component to the cord.

16. A method to enable the retaining of furniture using the furniture retaining apparatus of claim 1, comprising:
orienting the engaging component perpendicular to the sheet rock panel to thereby position the engaging end adjacent to the sheet rock panel;
striking the engaging component with force thereby driving the engaging component through the sheet rock panel;
threading a bight of the cord through the sheet rock panel when the engaging component is driven through the sheet rock panel;
inserting the retaining component through the insertion orifice of the furniture item;
forming the taut knot within the furniture item using the cord; and
positioning the taut knot adjacent to the retaining component and thereby frictionally coupling the retaining component adjacent to the insertion orifice.

17. The method of claim 16, wherein inserting the retaining component through the insertion orifice of the furniture item comprises:
forming the insertion orifice in the furniture item; and
inserting the retaining component and a working end of the cord through the insertion orifice.

18. The method of claim 17, wherein forming the taut knot within the furniture item using the cord comprises:
positioning the retaining component adjacent to the insertion orifice;
pulling the working end opposite the insertion orifice thereby making the bight taut; and
forming the taut knot using the working end.

19. The method of claim 18, further comprising:
forming an engaging orifice through the engaging component;
positioning the cord through the engaging orifice;
affixing the cord to the engaging component proximate to the engaging orifice; and
wherein the engaging orifice is oriented normal to the engaging component.

20. The method of claim 19, further comprising:
forming a retaining orifice through the retaining component; and
positioning the cord through the retaining orifice to thereby rotatably and slidingly couple the retaining component to the cord.
